(19) United States
(12) Patent Application Publication
(10) Pub. No.: US 2020/0249998 A1
(43) Pub. Date: Aug. 6, 2020

(54) SCHEDULING COMPUTATION GRAPH HETEROGENEOUS COMPUTER SYSTEM

(71) Applicant: ALIBABA GROUP HOLDING LIMITED, George Town (KY)

(72) Inventors: Shuai CHE, San Mateo, CA (US); Yingmin LI, San Mateo, CA (US); Ye YU, San Mateo, CA (US)

(73) Assignee: ALIBABA GROUP HOLDING LIMITED

(21) Appl. No.: 16/265,868

(22) Filed: Feb. 1, 2019

(51) Int. Cl. G06F 9/50; G06N 20/00; G06N 3/08

(52) U.S. Cl. CPC G06F 9/5027; G06N 3/08; G06N 20/00

(57) ABSTRACT

The present disclosure relates to a method for scheduling a computation graph on a heterogeneous computing resource including one or more target devices for executing the computation graph. The computation graph includes a plurality of nodes and edges, each edge connecting two nodes among the plurality of nodes. The method comprises partitioning the computation graph into a plurality of subsets, each subset includes at least two nodes, and generating one or more task allocation models for each subset of the plurality of subsets. Wherein a task allocation model of the one or more task allocation models includes information of an execution order of operations represented by the at least two nodes of the corresponding subset and of a target device of the one or more target devices for executing each of the operations. The method further comprises determining an optimized task allocation model for each of the plurality of subsets based on the generated one or more task allocation models, and combining each determined optimized task allocation model for each of the plurality of subsets into a combined model corresponding to the computation graph.

### BACKGROUND

Machine learning applications have been widely applied to solve problems in various fields including business, science, and engineering. For example, machine-learning technology can be used for business decision making process, medical analysis, image and speech recognition, machine translation, manufacturing process optimization, and so on. With the growth of machine-learning and deep-learning technologies, various types of heterogeneous computing devices or accelerators for machine learning or deep learning have begun to emerge. A heterogeneous platform including various accelerators that may not have equal processing performance has been used for machine learning applications. A typical machine-learning or deep-learning model may have thousands or even millions of variables and computation operations. Therefore, design space for scheduling tasks on various accelerators in a heterogeneous platform becomes extremely large as both of complexity of a computation graph and the number of accelerators have been rapidly increased.

### SUMMARY

Embodiments of the present disclosure provide a method for scheduling a computation graph on a heterogeneous computing resource including one or more target devices for executing the computation graph. The computation graph includes a plurality of nodes and edges, each edge connecting two nodes among the plurality of nodes. The method comprises partitioning the computation graph into a plurality of subsets, each subset includes at least two nodes, and generating one or more task allocation models for each subset of the plurality of subsets. Wherein a task allocation model of the one or more task allocation models includes information of an execution order of operations represented by the at least two nodes of the corresponding subset and of a target device of the one or more target devices for executing each of the operations. The method further comprises determining an optimized task allocation model for each of the plurality of subsets based on the generated one or more task allocation models, and combining each determined optimized task allocation model for each of the plurality of subsets into a combined model corresponding to the computation graph.

Embodiments of the present disclosure also provide an apparatus for scheduling a computation graph on a heterogeneous computing resource including one or more target devices for executing the computation graph. The computation graph includes a plurality of nodes and edges, each edge connecting two nodes among the plurality of nodes. The apparatus comprises a memory storing a set of instructions, and one or more processors configured to execute the set of instructions to cause the apparatus to perform: partitioning the computation graph into a plurality of subsets, each subset includes at least two nodes; generating one or more task allocation models for each subset of the plurality of subsets, wherein a task allocation model of the one or more task allocation models includes information of an execution order of operations represented by the at least two nodes of the corresponding subset and of a target device of the one or more target devices for executing each of the operations; determining an optimized task allocation model for each of the plurality of subsets based on the generated one or more task allocation models; and combining each determined optimized task allocation model for each of the plurality of subsets into a combined model corresponding to the computation graph.

Embodiments of the present disclosure also provide a non-transitory computer readable medium that stores a set of instructions that is executable by at least one processor of a computing device to cause the computing device to perform a method for scheduling a computation graph on a heterogeneous computing resource including one or more target devices for executing the computation graph. The computation graph includes a plurality of nodes and edges, each edge connecting two nodes among the plurality of nodes. The method comprises partitioning the computation graph into a plurality of subsets, each subset includes at least two nodes, and generating one or more task allocation models for each subset of the plurality of subsets. A task allocation model of the one or more task allocation models includes information of an execution order of operations represented by the at least two nodes of the corresponding subset and of a target device of the one or more target devices for executing each of the operations. The method further comprises determining an optimized task allocation model for each of the plurality of subsets based on the generated one or more task allocation models, and combining each determined optimized task allocation model for each of the plurality of subsets into a combined model corresponding to the computation graph.

The task allocation model can be represented by a sequence of nodes and a sequence of target devices. Partitioning the computation graph can be performed by cutting a single edge connecting two subsets of the plurality of the subsets. The method can further comprise replacing a subgraph including at least two nodes among the plurality of nodes included in the computation graph with a single node before partitioning the computation graph. Here, a target device among the plurality of the target devices for executing the single node replaced from the subgraph can be determined based on a prior execution history. The task allocation model of the one or more task allocation models can further include information of a processing element of the target device for executing each of the operations, and the task allocation model can be represented by a sequence of nodes and a sequence of processing elements in the target device.

Determining the optimized task allocation model can be performed based on reinforcement learning using a policy network. The policy network receives the task allocation model as an input and outputs an action among possible actions based on probability distribution over the actions. The action can correspond to a change on at least one of the execution order of the operations or the target device for executing one or more of the operations. The policy network can be updated according to a reward determined by performance evaluation of the action in runtime environments for executing the computation graph. The reward can be determined based on execution delay or memory usage efficiency.

### BRIEF DESCRIPTION OF THE DRAWINGS

FIG. 1 illustrates an exemplary accelerator architecture, consistent with embodiments of the present disclosure.

FIG. 2 illustrates an exemplary computing system having a heterogeneous platform, consistent with embodiments of the present disclosure.

FIG. 3 illustrates a block diagram of exemplary components of a scheduler, consistent with embodiments of the present disclosure.

FIG. 4 illustrates an example for graph optimization and partition, consistent with embodiments of the present disclosure.

FIG. 5 illustrates an example of algorithm performed in task allocation optimizer, consistent with embodiments of the present disclosure.

FIG. 6 illustrates an exemplary flow diagram for scheduling a computation graph on heterogeneous computing resource, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

A computing system for machine learning may have a heterogenous platform. The heterogenous platform may include various accelerators such as GPUs, FPGAs, and ASICs, each of which can be used to process operations of machine-learning or deep-learning model. The heterogeneous platform may include an accelerator in which processing elements do not have equal processing performance with each other. In machine learning or deep learning, a neural network model may be graphically represented by a computational graph or a data structure comprising nodes and edges organized as a directed acyclic graph (DAG). Nodes represent variables, weights, or computation operations, while edges represent dependency between operations. A typical machine-learning or deep-learning model may have thousands or even millions of variables and computation operations. As the size of a machine-learning model increases, task scheduling for executing the machine-learning model for inference encounters some issues because: 1) each operation represented by a node may be executed on multiple accelerators, 2) there are many ways to traverse a computation graph, that is, an order for executing operations can be various, and 3) data transfer overhead cannot be ignored when scheduling tasks. Therefore, the design space for task scheduling on a heterogenous platform can be considerably large as both complexity of a computation graph structure and the number of deployed accelerators increase, which makes it difficult to perform task scheduling in polynomial time.

The disclosed embodiments provide graph optimization techniques, graph partitioning techniques, or task allocation optimization techniques to solve the issues mentioned above. The disclosed embodiments also provide a method and apparatus for scheduling a computation graph on a heterogeneous platform, which can improve execution performance of a machine-learning model on the heterogeneous platform. The disclosed embodiments also provide a method and apparatus for task scheduling, which can allow efficient usage of resources of the computing system. The disclosed embodiments also provide a method and apparatus for improving inference performance by minimizing end-to-end inference delay based on optimized task schedule and device placement.

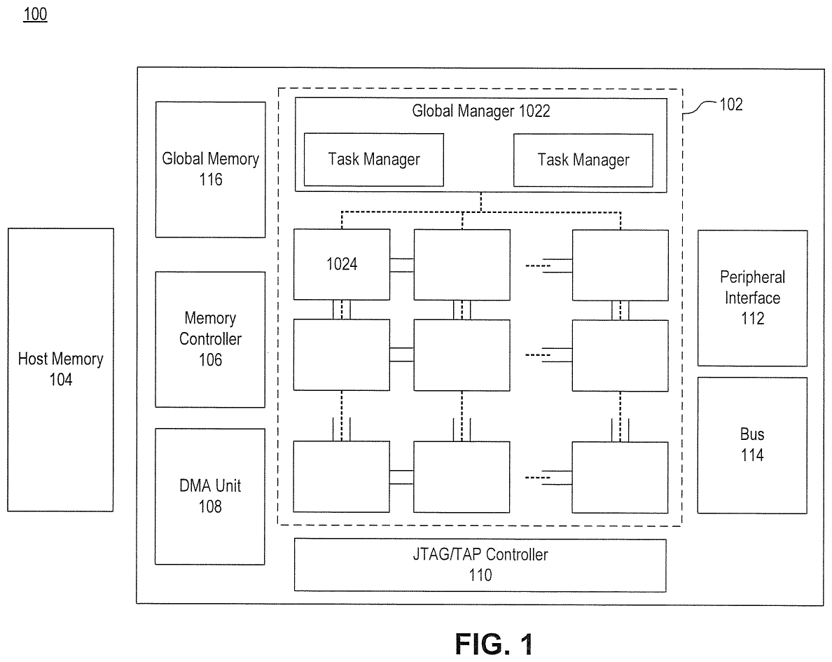

FIG. 1 illustrates an exemplary neural network processing unit (NPU) architecture 100, consistent with embodiments of the present disclosure. As shown in FIG. 1, NPU architecture 100 can include an on-chip communication system 102, a host memory 104, a memory controller 106, a direct memory access (DMA) unit 108, a Joint Test Action Group (JTAG)/Test Access End (TAP) controller 110, peripheral interface 112, a bus 114, a global memory 116, and the like. It is appreciated that on-chip communication system 102 can perform algorithmic operations based on communicated data. Moreover, NPU architecture 100 can include a global memory 116 having memory blocks (e.g., 4 blocks of 8 GB second generation of high bandwidth memory (HBM2)) to serve as main memory.

Chip communication system 102 can include a global manager 1022 and a plurality of cores 1024. Global manager 1022 can include at least one task manager to coordinate with one or more cores 1024. Each task manager can be associated with an array of cores 1024 that provide synapse/neuron circuitry for the neural network. For example, the top layer of cores of FIG. 1 may provide circuitry representing an input layer to neural network, while the second layer of cores may provide circuitry representing a hidden layer of the neural network. As shown in FIG. 1, global manager 1022 can include two task managers to coordinate with two arrays of cores 1024.

Cores 1024 can include one or more processing elements that each includes single instruction, multiple data (SIMD) architecture including one or more processing units configured to perform one or more operations (e.g., multiplication, addition, multiply-accumulate, etc.) on the communicated data under the control of global manager 1022. To perform the operation on the communicated data packets, cores 1024 can include one or more processing elements for processing information in the data packets. Each processing element may comprise any number of processing units. In some embodiments, core 1024 can be considered a tile or the like

Host memory 104 can be off-chip memory such as a host CPU's memory. For example, host memory 104 can be a DDR memory (e.g., DDR SDRAM) or the like. Host memory 104 can be configured to store a large amount of data with slower access speed, compared to the on-chip memory integrated within one or more processors, acting as a higher-level cache.

Memory controller 106 can manage the reading and writing of data to and from a specific memory block (e.g., HBM2) within global memory 116. For example, memory controller 106 can manage read/write data coming from outside chip communication system 102 (e.g., from DMA unit 108 or a DMA unit corresponding with another NPU) or from inside chip communication system 102 (e.g., from a local memory in core 1024 via a 2D mesh controlled by a task manager of global manager 1022). Moreover, while one memory controller is shown in FIG. 1, it is appreciated that more than one memory controller can be provided in NPU architecture 100. For example, there can be one memory controller for each memory block (e.g., HBM2) within global memory 116.

Memory controller 106 can generate memory addresses and initiate memory read or write cycles. Memory controller 106 can contain several hardware registers that can be written and read by the one or more processors. The registers can include a memory address register, a byte-count register, one or more control registers, and other types of registers. These registers can specify some combination of the source, the destination, the direction of the transfer (reading from the input/output (I/O) device or writing to the I/O device), the size of the transfer unit, the number of bytes to transfer in one burst, and/or other typical features of memory controllers.

DMA unit 108 can assist with transferring data between host memory 104 and global memory 116. In addition, DMA unit 108 can assist with transferring data between multiple NPUs (e.g., NPU 100). DMA unit 108 can allow off-chip devices to access both on-chip and off-chip memory without causing a host CPU interrupt. Thus, DMA unit 108 can also generate memory addresses and initiate memory read or write cycles. DMA unit 108 also can contain several hardware registers that can be written and read by the one or more processors, including a memory address register, a byte-count register, one or more control registers, and other types of registers. These registers can specify some combination of the source, the destination, the direction of the transfer (reading from the input/output (I/O) device or writing to the I/O device), the size of the transfer unit, and/or the number of bytes to transfer in one burst. It is appreciated that NPU architecture 100 can include a second DMA unit, which can be used to transfer data between other NPU architecture to allow multiple NPU architectures to communicate directly without involving the host CPU.

JTAG/TAP controller 110 can specify a dedicated debug port implementing a serial communications interface (e.g., a JTAG interface) for low-overhead access to the NPU without requiring direct external access to the system address and data buses. JTAG/TAP controller 110 can also have on-chip test access interface (e.g., a TAP interface) that implements a protocol to access a set of test registers that present chip logic levels and device capabilities of various parts.

Peripheral interface 112 (such as a PCIe interface), if present, serves as an (and typically the) inter-chip bus, providing communication between the NPU and other devices.

Bus 114 includes both intra-chip bus and inter-chip buses. The intra-chip bus connects all internal components to one another as called for by the system architecture. While not all components are connected to every other component, all components do have some connection to other components they need to communicate with. The inter-chip bus connects the NPU with other devices, such as the off-chip memory or peripherals. Typically, if there is a peripheral interface 112 (e.g., the inter-chip bus), bus 114 is solely concerned with intra-chip buses, though in some implementations it could still be concerned with specialized inter-bus communications.

While NPU architecture 100 of FIG. 1 incorporates the embodiments of the present disclosure, it is appreciated that the disclosed embodiments can be applied to any accelerator such as a chip with SIMD architecture for accelerating some applications such as deep learning. Such accelerators can be, for example, GPU (Graphics Processing Unit), FPGA (Field Programmable Gate Array), CPU (Central Processing Unit), ASIC (Application Specific Integrated Circuit) with vector or matrix processing ability, or other types of neural network accelerators for deep learning. SIMD or vector architecture is commonly used to support computing devices with data parallelism, such as graphics processing and deep learning. The SIMD architecture can include multiple processing elements, wherein each of the processing elements can perform the same operation on multiple data points simultaneously.

In some embodiments, neural network processors comprise a compiler (not shown). The compiler is a program or computer software that transforms computer code written in one programming language into NPU instructions to create an executable program. In machining applications, a compiler can perform a variety of operations, for example, pre-processing, lexical analysis, parsing, semantic analysis, conversion of input programs to an intermediate representation, code optimization, and code generation, or combinations thereof.

In some embodiments, the compiler that generates the instructions can be on a host unit (e.g., CPU having host memory 104), which pushes commands to NPU 100. Based on these commands, each task manager can assign one or more free cores to a new task and manage synchronization between cores if necessary. Some of the commands can instruct DMA unit 108 to load the instructions (generated by the compiler) and data from host memory 104 into global memory 116. The loaded instructions can then be distributed to the instruction buffer of each core assigned with the corresponding task, and the core can process these instructions accordingly.

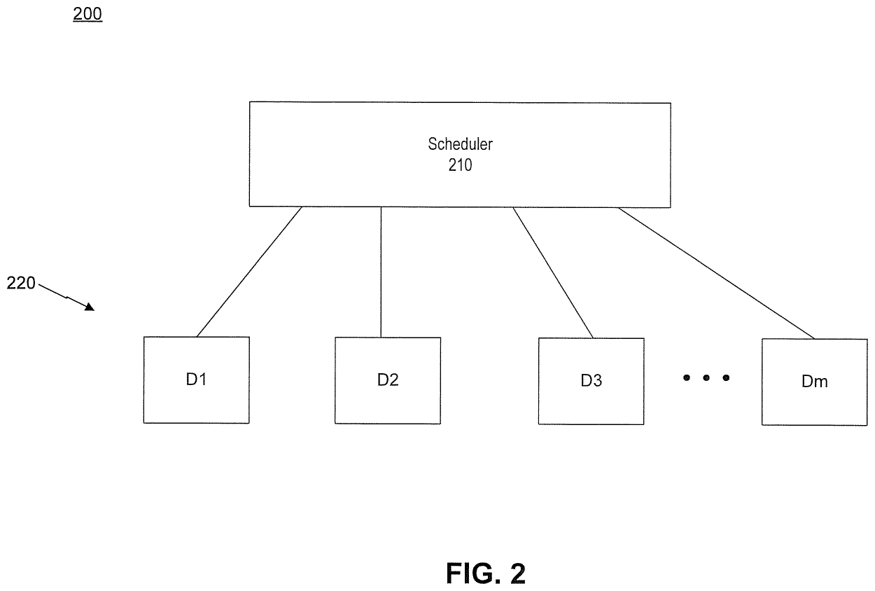

FIG. 2 illustrates an exemplary computing system 200 having a heterogeneous platform, consistent with embodiments of the present disclosure. Computing system 200 includes a scheduler 210 and heterogeneous computing resource 220. In some embodiments, the heterogeneous computing resource 220 may include a plurality of target devices D1 to Dm. In some embodiments, the heterogeneous computing resource 220 may include one target device in which processing elements do not have equal processing performance. Scheduler 210 is configured to schedule tasks with respect to execution order of operations and which operation is processed in which target device or which operation is processed in which processing element. In some embodiments of the present disclosure, scheduler 210 may be any form including, but not limited to executable instructions stored in a computer readable medium for use by or in connection with a computing device including one or more processors. In some embodiments, scheduler 210 may be implemented as logic and/or circuitry configured to perform operations of the executable instructions. In some embodiments, scheduler 210 may be implemented within a compiler. In some embodiments, scheduler 210 may be implemented in runtime libraries.

Heterogeneous computing resource 220 may include a plurality of target devices D1 to Dm that may not have equal processing performance. In some embodiments, at least two of the plurality of target devices D1 to Dm may have different architecture with each other. In some embodiments, target devices D1 to Dm can be implemented as any one of CPU, GPU, FPGA, ASIC, etc. In some embodiments, at least two of the plurality of target devices D1 to Dm may have different processing speeds, power consumptions, transfer costs, etc. In some embodiments, a certain target device may be configured to be specialized to process a certain operation with high performance such as low cost and high accuracy. In some embodiments, the target devices D1 to Dm can be accelerators having, for example, the NPU architecture 100 of FIG. 1. In some embodiments, the heterogeneous computing resource 220 may include one target device in which processing elements do not have equal processing performance.

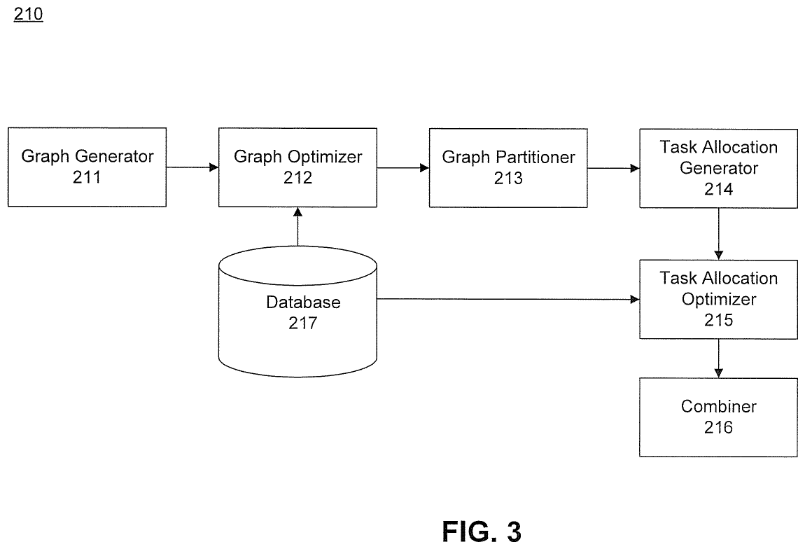

Execution performance of a computing system 200 having a heterogeneous platform, for example, shown in FIG. 2 can be improved by optimizing execution order of operations or identifying optimal target devices for executing corresponding operations. In embodiments of the present invention, scheduler 210 is configured to provide optimized task allocation including execution order of operations and device placement for executing the operations, which will be described in detail referring to FIG. 3 to FIG. 5. In some embodiments, the device placement for executing the operations can include processing element placement for executing the operations in one target device.

FIG. 3 illustrates a block diagram of exemplary components of a scheduler 210, consistent with embodiments of the present disclosure. As shown in FIG. 3, scheduler 210 can include a graph generator 211, graph optimizer 212, graph partitioner 213, task allocation generator 214, task allocation optimizer 215, and combiner 216.

Graph generator 211 can compile a source code for a machine-learning model or neural network model to generate a computation graph representing the source code. In some embodiments, graph generator 211 may transform a machine-learning model or neural network model written in high level language to generate a computation graph representing the machine-learning model or neural network model. In some embodiments, the computation graph can be generated from another high-level code initially compiled from the source code. In some embodiments, the machine-learning model may be a trained frozen machine-learning model. In some embodiments, the graph generator 211 can generate a computation graph in a form of a Directed Acyclic Graph (DAG) by parsing a machine-learning model. In machine learning (ML) or deep learning (DL), a neural network model may be graphically represented by a computational graph or a data structure comprising nodes and edges organized as a directed acyclic graph (DAG). Nodes represent variables, weights, or computation operations, while edges represent data or tensor flowing from one node to another. An incoming edge to a node representing a computation operation is input data consumed by the computation operation, while an outgoing edge from the node represents output data produced by the computation operation.

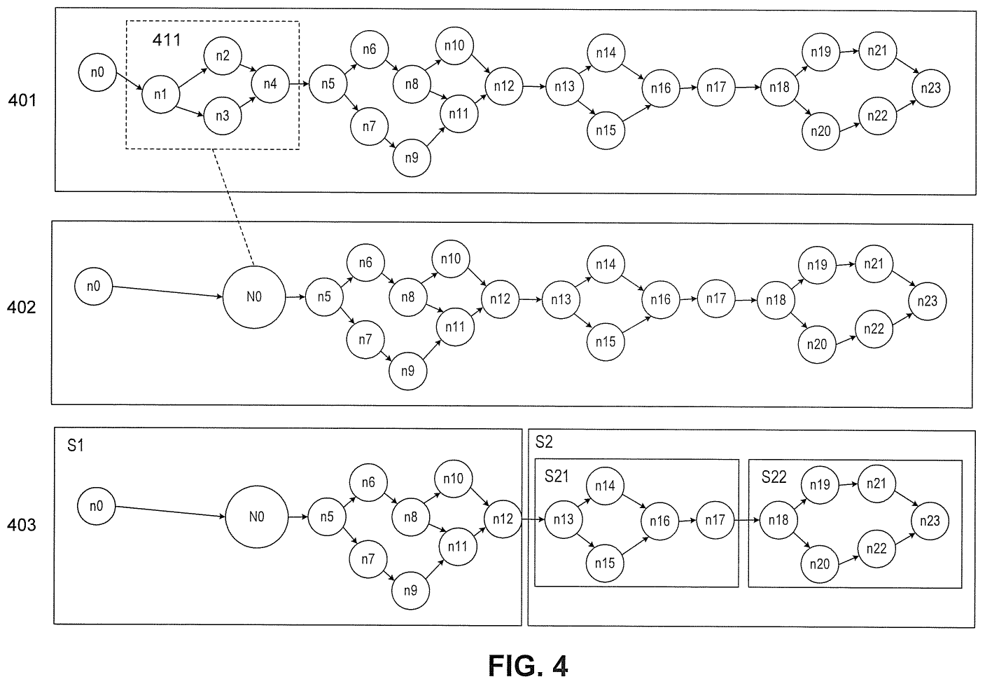

An example of a computation graph generated by graph generator 211 is illustrated as state 401 in FIG. 4. As shown at state 401, a computation graph includes a plurality of nodes n0 to n23 and edges connecting two nodes among the plurality of nodes n0 to n23. In some embodiments, any number of nodes and edges can be included in a computation graph. In some embodiments, some nodes n0 to n23 can include information such as a type of operation, dimensions of data structure, input node(s), output node(s), etc. Here, the operation may include a convolution (Cony), ReLU, multiplication (MatrixMul), etc. In some embodiments, some other nodes n0 to n23 may be non-operational nodes and can include weights and other parameters such as constants. Edge can represent dependency between two nodes connected by the corresponding edge. That is, a node at the end point of the edge can be processed only after a node at the start point of the edge is processed. For example, node n16 can be processed only after node n14 and node n15 are processed and the outputs of the nodes n14 and n15 are provided to the node n16.

Referring back to FIG. 3, graph optimizer 212 is configured to optimize a computation graph generated by the graph generator 211, consistent with embodiments of the present disclosure. In some embodiments, graph optimizer 212 can simplify the structure of the computation graph to reduce complexity of task scheduling. For example, the graph optimizer 212 can be configured to replace a subgraph of the computation graph including at least two nodes with a single node, which can be called a super node in this specification. Referring back to FIG. 4, an example of the computation graph simplified by the graph optimizer 212 is illustrated as state 402. A subgraph indicated by a reference number 411 and a dotted box in the computation graph of state 401 is replaced with a super node N0 at state 402. While the subgraph 411 including 4 nodes and four edges are replaced with a super node N0 in this example, a subgraph including any number of nodes and edges can be replaced with one super node according to some embodiments of the present disclosure. Also, two or more subgraphs can be replaced with corresponding super nodes according to some embodiments of the present disclosure. The super node may be treated as a regular node in the following processes for task scheduling, consistent with embodiments of the present disclosure.

In some embodiments, the graph optimizer 212 may refer to database 217 to optimize a computation graph. The database 217 may store various information including: 1) system and target device information, 2) operation profiling information per target device, and 3) subgraph profiling information per target device. The system information may include interconnect bandwidth information between target devices or between a host device and target device. The target device information may include computing throughput information and memory bandwidth. The operation profiling information may include execution time or speed information and delay information of a target device for executing a certain operation such as a convolution, matrix multiplication, etc. The operation profiling information can be estimated by simulations or obtained by previous experiments on each of target devices. In some embodiments, operation profiling information for each of the target devices can be stored for each of operations. The subgraph profiling information may include execution time or speed information and delay information of a target device. The subgraph profiling information can be estimated by simulations or obtained by previous experiments on each of target devices. In some embodiments, subgraph profiling information for each of the target devices can be stored for each of subgraphs. In some embodiments, the database 217 can be implemented as a part of scheduler 210. In some embodiments, the database 216 can be implemented separately from the scheduler 210 and can communicate with the scheduler 210 via a wired or wireless network.

In some embodiments, the graph optimizer 212 may use the subgraph profiling information to optimize a computation graph. A computation graph may include some subgraphs that are commonly used in many machine learning models as their components. For example, the commonly used subgraphs can include MobileNets layers, ResNet layers, Region Proposal Network, etc. In some embodiments, prior history of execution, experiments, or simulations can show optimized execution order and device placements for a certain subgraph. Some commonly used large subgraphs can be fully offloaded to a certain target device such as ASIC or FPGA without customizing the schedule, and thus analysing the subgraphs may be disregarded when scheduling, consistent with embodiments of the present disclosure. Therefore, replacing some subgraphs with corresponding super nodes by the graph optimizer can reduce the complexity of the scheduling process. In some embodiments, when scheduling tasks of a computation graph, device placement for a certain super node may be restricted to a certain target device. In some embodiments, the graph optimizer 212 can also perform any optimization techniques such as layer fusions or node clustering to maximize performance of target devices, if it's applicable. It is appreciated that replacing a subgraph with a super node may be omitted in some embodiments.

Graph partitioner 213 is configured to divide a computation graph into a plurality of subsets, consistent with embodiments of the present disclosure. In some embodiments, the computation graph to be divided by the graph partitioner 213 can be fed from the graph optimizer 212. In some embodiments, the computation graph to be divided by the graph partitioner 213 can be a computation graph generated by the graph generator 211. Referring back to FIG. 4, an example of the computation graph divided by the graph partitioner 213 is illustrated as state 403. In this example, the graph partitioner 213 divides the computation graph of state 402 that has been optimized by the graph optimizer 212 and that includes super node N0.

In state 403, it is shown that the computation graph is divided into two subsets S1 and S2. In state 403, it is also shown that the subset S2 is divided into two smaller subsets S21 and S22. As such, partitioning process can be performed to divide the computation graph into a plurality of subsets and then to divide at least one of the subsets into a plurality of smaller subsets in some embodiments. In some embodiments, partitioning process can be performed recursively until each of the subsets includes an appropriate number of nodes and edges. It is appreciated that other partitioning processes can be used depending on embodiments of the present disclosure. For example, the partitioning process can be performed sequentially from a start point to an end point of the computation graph such that a first subset including an appropriate number of nodes and edges are defined from the start point of the computation graph, then a second subset including an appropriate number of nodes and edges from the end point of the first subset is defined, and subsets for the rest portion of the computation graph can be sequentially defined in a similar manner. In some embodiments, the appropriate number of nodes and edges for a subset can be determined based on available accelerator resources, each accelerator's capacity, time requirements, properties of a data structure, and so on.

In some embodiments, partitioning can be performed recursively until termination criterion is met. It is appreciated that the termination criterion can vary depending on embodiments and runtime environments. In some embodiments, the termination criterion can be a size of the subset such as the number of nodes and edges included in the subset or a total number of subsets. For example, the termination criterion can be determined based on available computing resources for task scheduling, available accelerator resources, time requirements, properties of a data structure, and so on according to embodiments of the present disclosure. In some embodiments, the termination criterion can be determined based on the results of simulations or experiments in runtime environments.

When partitioning a computation graph, the graph partitioner 213 may consider computation graph's properties of many machine-learning models. As illustrated in state 403, it is observed that there are single edges in a computation graph, each of which connecting two node clusters. For example, single edge between nodes n12 and n13 connects one node cluster including nodes n5 to n12 and another node cluster including nodes n13 to n16. It is appreciated that a computation graph representing a machine-learning model may include multiple single edges. In some embodiments, partitioning subsets at such single edges allows independent optimization on task allocation for each individual subset. In some embodiments, graph partitioning techniques such as minimum cut algorithm can be used to cut the computation graph into subsets by the graph partitioner 213.

Task allocation including execution order and device placement can be determined per a subset of a computation graph, and then task allocation for the whole computation graph can be generated by combining each subset's task allocation result, consistent with embodiments of the present disclosure. While the process for task allocation on one subset will be explained hereinafter, it is appreciated that task allocation for other subsets can be performed in a similar manner.

Referring to FIG. 3, task allocation generator 214 is configured to generate one or more task allocation models for each subset of a computation graph, consistent with embodiments of the present disclosure. In some embodiments, the task allocation model includes execution order of operations represented by nodes in a subset and device placements for each of the corresponding operations. In some embodiments, the task allocation generator 214 may produce a sequence of nodes for representing an execution order of operations and a sequence of target devices corresponding to the sequence of nodes. The task allocation model for a subset S21 generated by task allocation generator 214 will be explained as an example referring to state 403 of FIG. 4. The sequence of nodes for the subset S21 generated by the task allocation generator 214 may be in a form [n13, n15, n14, n16, n17], which means node n13 is executed first, then node n15, node n14, node n16, and node n17 are executed in that order. Here, the order of execution is generated to meet the dependency constraint of the computation graph. For example, an operation represented by node n16 cannot be executed before the operations represented by nodes n14 and n15 are executed. The sequence of target devices for the subset S21 generated by the task allocation generator 214 may be in a form [D1, D4, D3, D2, D3], which shows the sequence of target devices to execute corresponding operations represented by the sequence of nodes [n13 n15, n14, n16, n17]. In this example, it will be known from the sequences of target devices and nodes, the operation represented by node n13 will be executed in a first target device D1, the operation represented by node n15 will be executed in a fourth target device D4, and so on. As discussed earlier, a target device can be CPU, GPU, FPGA, ASIC, or any other type of devices.

In some embodiments, the task allocation generator 214 may produce a sequence of nodes for representing an execution order of operations and a sequence of processing elements in one target device corresponding to the sequence of nodes. While task allocation optimization regarding a heterogeneous platform including a plurality of target devices is described here, it is appreciated that task allocation optimization for a heterogeneous platform including one target device having a plurality of processing elements can be performed in a same or similar manner.

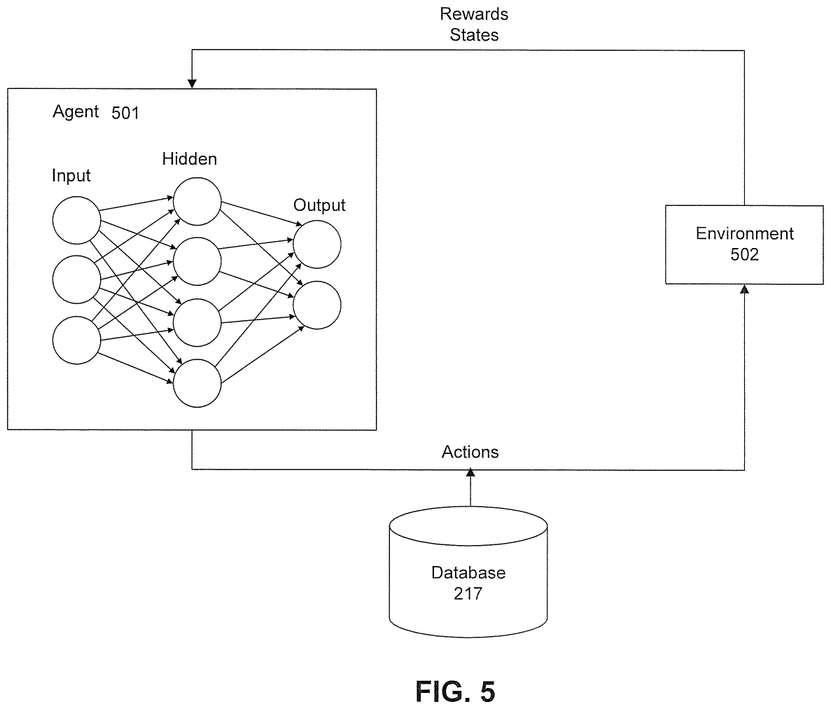

Referring to FIG. 3, task allocation optimizer 215 is configured to determine an optimized task allocation model based on the generated one or more task allocation models, consistent with embodiments of the present disclosure. The optimization of the task allocation optimizer 215 is performed per a subset of the computation graph. In some embodiments, the task allocation optimizer 215 may use a reinforcement learning algorithm to optimize both the execution order and device placement. The reinforcement learning algorithm used by the task allocation optimizer 215 will be explained referring to FIG. 5, which illustrates an example of process performed in task allocation optimizer 215, consistent with embodiments of the present disclosure.

In reinforcement learning, an agent 501 makes observations to an environment 502 and takes actions within the environment 502 (e.g., such as a run-time environment where the computation graph is or will be executed), and in return the agent 501 receives rewards from the environment 502. The reinforcement learning's objective is to learn to act in a way to maximize its long-term rewards, which can be positive or negative. The agent 501 can use a policy network to determine its actions. In FIG. 5, the policy network of the agent 501 is illustrated as a neural network including input layer, output layer, and one or more hidden layers. Consistent with embodiments of the present disclosure, any policy-based neural network can be used as the policy network for the agent 501. In some embodiments, in addition to activation layers (e.g., ReLU), a multi-layer perception (MLP) or a combination of 1D convolutions and fully connected layers can be used for the policy network of the agent 501. The policy network takes task allocation models as inputs and outputting actions to take. In some embodiments, the policy network of the agent 501 may generate a probability distribution over all possible actions. An action can be taken according to this probability distribution, leading to a new state or task allocation model with a reward. This reward can be used to update the policy network in a way that the policy network encourages actions with high rewards (or positive rewards) and discourages actions with low rewards (or negative rewards). Terms for reinforcement learning consistent with embodiments of the present disclosure are described below.

For example, a state or task allocation model can be represented as one or more values corresponding to a sequence of nodes and a sequence of devices [node, device]. That is, the state can be considered as one position in the entire design space.

An action can involve any change on either the sequence of nodes or sequence of target devices. In some embodiments, the actions can be evaluated using an analytical or cost model of the environment 502.

For a sequence of nodes, a change in the sequence of nodes can be an action. For example, a new sequence of nodes [n13, n14, n15, n16, n17], which is different from the original [n13, n15, n14, n16, n17] and still meets the dependency requirement for the subset S21, can be chosen as an action. For a sequence of target devices, a target device change in at least one position of the inputted sequence of target devices can be an action. For example, the target device D2 on the fourth position in the sequence of target devices [D1, D4, D3, D2, D3] can be changed to a target device D4, which can be considered as an action. That is, the agent 501 can take an action to change a target device to execute a certain operation represented by a node (e.g., FPGA to GPU).

In some embodiments, before taking an action, the task allocation optimizer 215 may refer to database 217 to check whether there is any constraints or preferences on task allocation from prior knowledge. A certain target device may be specialized in executing certain operations or a certain target device may not be proper to execute certain operations. For example, it may be shown from the profiling information stored in the database 217 that ASIC is efficient in executing matrix operations on matrices with large dimensions. In some embodiments, some actions (e.g., assigning a matrix operation on a target device other than ASIC) may be bypassed by the agent 501 when taking an action.

The environment 502 can be runtime environments for executing the computation graph, consistent with embodiments of the present disclosure. In some embodiments, the runtime environments provide a state of heterogeneous computing resource including plurality of target devices to have access to resources such as software libraries and system variables, and provides services and support for executing the computation graph.

A reward can involve an end-to-end inference delay given a particular state. For example, given a state, the end-to-end delay for executing the corresponding subset can be used as a reward for each step. If the delay is longer, the value of the reward can be smaller or negative. If the delay is shorter, the value of the reward can be larger or positive. In some embodiments, the execution time for an individual operation can be obtained from the database 217 storing operation profiling information. In some embodiments, the execution time for individual operations can be estimated by analytical or cost model for the environment based on the sizes of data structures, operation type, computing throughput, or memory bandwidth of the system. When evaluating the performance based on the execution delay, data transfer overhead can be also taken into account if two nodes connected by a common edge are assigned to two different target devices. The data transfer overhead can be estimated or calculated based on the size of data structures, link bandwidth, and so on.

In some embodiments, the reward can reflect memory consumption efficiency during the execution. Executing a machine-learning model usually consumes significant memory capacity, thus it has become important to optimize memory consumption specially on client end terminals. Embodiments of the present disclosure may consider the memory consumption efficiency factor when optimizing task allocation. In some embodiments, memory usage during execution of a computation graph can be obtained by applying liveness analysis. In some embodiments, the memory usage can be calculated based on the size of the data structures such as the number of nodes included in a computation graph. The memory assigned to a certain node can be released if all the dependent nodes on the certain node are executed and there are no other nodes depending on the certain node (e.g., the memory can be reused or reassigned to a new node different from the certain node). In this way, memory usage efficiency can be improved by increasing the reuse rate of memory during execution. In some embodiments, memory usage efficiency for a certain memory can be obtained by a ratio of a time period that the certain memory is in use (e.g., the memory is live) to a pre-set time period. Therefore, the whole memory usage efficiency in the system can be obtained based on each memory's memory usage efficiency. In some embodiments, the reward for a certain state including a sequence of nodes and a sequence of target devices can reflect memory usage efficiency such that the value of the reward is bigger if the memory usage efficiency is higher.

In some embodiments, a reward function can be configured to optimize other factors in runtime environments. In some embodiments, the reward function can be modified to optimize both memory usage and performance of the system. For example, when memory consumption of individual operation is known, it can be determined how many operations can be executed concurrently in a target device, and thus multiple operations can be assigned to the same target device for throughput improvement. In some embodiments, the reward can be determined based on multiple factors. For example, the reward can be determined based on a combined value of the weighted factors. Here, the weights of the multiple factors can be set different from each other.

As explained above, the task allocation optimizer 215 produces an optimized task allocation model, for example, including a sequence of nodes and a sequence of target devices for a subset of a computation graph. The processes for a subset S21 performed by the task allocation generator 214 and task allocation optimizer 215 can be repeated for each of the subsets S1 and S22 included in the computation graph in parallel or sequentially with the process for the subset S21.

Combiner 216 is configured to combine optimized task allocation from the task allocation optimizer 215 for all the subsets in the computation graph, consistent with embodiments of the present disclosure. By combining optimized task allocation models for all the subsets in the computation graph, a combined model corresponding to the whole computation graph can be obtained.

While components of the scheduler 210 in FIG. 2 are explained as a separate component with each other in the present disclosure, it will be appreciated that at least some of the components can be implemented as one component, consistent with embodiments of the present disclosure. For example, the task allocation generator 214, task allocation optimizer 215, and combiner 216 can be implemented in one component. In some embodiments, at least some of the components can be implemented in other device or apparatus, which communicates with the rest of the components of the scheduler 210 via wired or wireless networks.

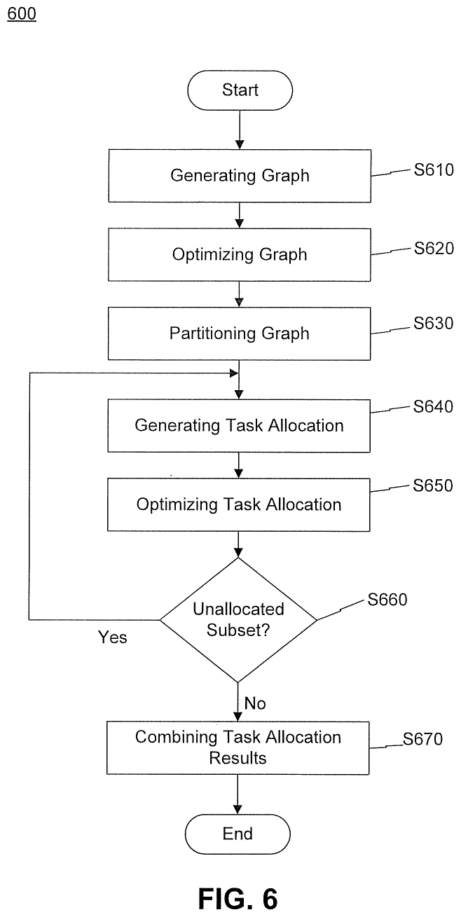

FIG. 6 illustrates an exemplary flow diagram for scheduling a computation graph on heterogeneous computing resource, consistent with embodiments of the present disclosure. At step S610, a computation graph representing a source code for a machine-learning model is generated. As shown n state 401, the generated computation graph may include a plurality of nodes and edges and be in a form of a Directed Acyclic Graph (DAG).

At step S620, the generated computation graph can be optimized. For example, the computation graph can be simplified by replacing a subgraph with a super node. As shown in state 402, a subgraph 411 of state 401 is replaced with a super node N0. Also, two or ore subgraphs can be replaced with corresponding super nodes according to some embodiments of the present disclosure. The super node may be treated as a regular node in the following processes for task scheduling, consistent with embodiments of the present disclosure. In some embodiments, any optimization techniques such as layer fusions or node clustering can be performed on the computation graph.

At step S630, a computation graph can be divided into a plurality of subsets, consistent with embodiments of the present disclosure. As shown in state 403, the computation graph is divided into two subsets S1 and S2. In state 403, it is also shown that the subset S2 is divided into two smaller subsets S21 and S22. As such, the partitioning process can be performed to divide the computation graph into a plurality of subsets and then to divide at least one of the subsets into a plurality of smaller subsets in some embodiments. In some embodiments, partitioning process can be performed recursively until each of the subsets includes appropriate number of nodes and edges. In some embodiments, partitioning can be performed recursively until termination criterion is met. It is appreciated that the termination criterion can vary depending on embodiments and runtime environments. In some embodiments, the termination criterion can be a size of the subset such as the number of nodes and edges included in the subset or a total number of subsets. In some embodiments, partitioning can be performed by cutting a single edge connecting two node clusters. In some embodiments, partitioning subsets at such single edges allows independent optimization on task allocation for each individual subset.

At step 640, one or more task allocation models for a first subset of a computation graph can be generated. In some embodiments, the task allocation model includes an execution order of operations represented by nodes in a subset and device placements for each of the corresponding operations. In some embodiments, a sequence of nodes for representing execution order of operations and a sequence of target devices corresponding to the sequence of nodes can be generated as the task allocation for the first subset. In some embodiments, the task allocation generator 214 may produce a sequence of nodes for representing an execution order of operations and a sequence of processing elements in one target device corresponding to the sequence of nodes. While task allocation optimization process regarding a heterogeneous platform including a plurality of target devices is described below, it is appreciated that task allocation optimization process for a heterogeneous platform including one target device having a plurality of processing elements can be performed in a same or similar manner.

At step 650, an optimized task allocation model can be determined. The optimization can be performed based on reinforcement learning using a policy network as shown in FIG. 5. The policy network receives the task allocation model as an input and outputs an action among possible actions based on probability distribution over the actions. The policy network is updated according to a reward determined by performance evaluation of the action in runtime environments for executing the computation graph. In some embodiments, the reward is determined based on execution delay or memory usage efficiency. The action includes a change on the execution order or target device information. A new sequence of nodes, which is different from the originally inputted sequence of nodes and still meets the dependency requirement of a computation graph, can be an action. For a sequence of target devices, a target device change in at least one position of the inputted sequence of target devices can be an action. In some embodiments, before taking an action, database 217 can be referred to for checking whether there are any constraints or preferences on the task allocation from prior knowledge. In some embodiments, some actions (e.g., assigning a matrix operation on a target device other than ASIC) may be bypassed by the algorithms when taking an action.

Step S640 and step S650 can be repeated for all subsets included in the computation graph. The steps S640 and S650 for all subsets can be performed in parallel or sequentially. At step S660, if there is no subset for task allocation, the process proceeds to step S670. At step S670, the optimized task allocation models for all the subset in the computation graph can be combined to obtain a combined model corresponding to the whole computation graph.

Embodiments of the present disclosure provide a method and technique for optimizing execution order and device placement for a computation graph representing a machine-learning model to obtain a higher performance in the acceleration system. According to embodiments of the present disclosure, it is possible to reduce design space for obtaining optimized task allocation for a computation graph by partitioning the computation graph into a plurality of subsets. According to embodiments of the present disclosure, the design space can be further reduced by treating a portion of the computation graph as a single node when optimizing the execution order and device placement. According to embodiments of the present disclosure, profiling information and prior execution history can be used to further reduce the design space for optimizing execution order and device placement. According to embodiments of the present disclosure, reinforcement learning technique can be used for optimizing both of execution order and device placement for each subset of a computation graph. Embodiments of the present disclosure can provide scheduling technique to achieve minimal end-to-end execution delay for a computation graph by making design space smaller.

Embodiments herein include database systems, methods, and tangible non-transitory computer-readable media. The methods may be executed, for example, by at least one processor that receives instructions from a tangible non-transitory computer-readable storage medium. Similarly, systems consistent with the present disclosure may include at least one processor and memory, and the memory may be a tangible non-transitory computer-readable storage medium. As used herein, a tangible non-transitory computer-readable storage medium refers to any type of physical memory on which information or data readable by at least one processor may be stored. Examples include random access memory (RAM), read-only memory (ROM), volatile memory, non-volatile memory, hard drives, CD ROMs, DVDs, flash drives, disks, registers, caches, and any other known physical storage medium. Singular terms, such as “memory” and “computer-readable storage medium,” may additionally refer to multiple structures, such a plurality of memories and/or computer-readable storage media. As referred to herein, a “memory” may comprise any type of computer-readable storage medium unless otherwise specified. A computer-readable storage medium may store instructions for execution by at least one processor, including instructions for causing the processor to perform steps or stages consistent with embodiments herein. Additionally, one or more computer-readable storage media may be utilized in implementing a computer-implemented method. The term “computer-readable storage medium” should be understood to include tangible items and exclude carrier waves and transient signals.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

1. A method for scheduling a computation graph on a heterogeneous computing resource including one or more target devices for executing the computation graph, the computation graph including a plurality of nodes and edges, each edge connecting two nodes among the plurality of nodes, the method comprising:
partitioning the computation graph into a plurality of subsets, each subset includes at least two nodes;
generating one or more task allocation models for each subset of the plurality of subsets, wherein a task allocation model includes information of an execution order of operations represented by at least two nodes of the corresponding subset and of a target device of the one or more target devices for executing each of the operations;
determining an optimized task allocation model for each of the plurality of subsets based on the generated one or more task allocation models; and
combining each determined optimized task allocation model for each of the plurality of subsets into a combined model corresponding to the computation graph.

2. The method of claim 1, wherein the task allocation model is represented by a sequence of nodes and a sequence of target devices.

3. The method of claim 1, wherein partitioning the computation graph is performed by cutting a single edge connecting two subsets of the plurality of the subsets.

4. The method of claim 1, further comprising:
replacing a subgraph including at least two nodes among the plurality of nodes included in the computation graph with a single node before partitioning the computation graph.

5. The method of claim 4, wherein a target device among the one or more target devices for executing the single node replaced from the subgraph is determined based on a prior execution history.

6. The method of claim 1, wherein:
determining the optimized task allocation model is performed based on reinforcement learning using a policy network,
the policy network receives the task allocation model as an input and outputs an action among possible actions based on probability distribution over the actions, the action corresponding to a change on at least one of the execution order of the operations or the target device for executing one or more of the operations,
the policy network is updated according to a reward determined by performance evaluation of the action in runtime environments for executing the computation graph.

7. The method of claim 6, wherein the reward is determined based on execution delay or memory usage efficiency.

8. The method of claim 1, wherein the task allocation model further includes information of a processing element of the target device for executing each of the operations, and the task allocation model is represented by a sequence of nodes and a sequence of processing elements.

9. An apparatus for scheduling a computation graph on a heterogeneous computing resource including one or more target devices for executing the computation graph, the computation graph including a plurality of nodes and edges, each edge connecting two nodes among the plurality of nodes, the apparatus comprising:
a memory storing a set of instructions; and
one or more processors configured to execute the set of instructions to cause the apparatus to perform:
partitioning the computation graph into a plurality of subsets, each subset includes at least two nodes;
generating one or more task allocation models for each subset of the plurality of subsets, wherein a task allocation model includes information of an execution order of operations represented by at least two nodes of the corresponding subset and of a target device of the one or more target devices for executing each of the operations;
determining an optimized task allocation model for each of the plurality of subsets based on the generated one or more task allocation models; and
combining each determined optimized task allocation model for each of the plurality of subsets into a combined model corresponding to the computation graph.

10. The apparatus of claim 9, wherein the task allocation model is represented by a sequence of nodes and a sequence of target devices.

11. The apparatus of claim 9, wherein partitioning the computation graph is performed by cutting a single edge connecting two subsets of the plurality of the subsets.

12. The apparatus of claim 9, wherein the one or more processors are configured to execute the set of instructions to cause the apparatus to further perform:
replacing a subgraph including at least two nodes among the plurality of nodes included in the computation graph with a single node before partitioning the computation graph.

13. The apparatus of claim 12, wherein a target device among the one or more target devices for executing the single node replaced from the subgraph is determined based on a prior execution history.

14. The apparatus of claim 9, wherein:
determining the optimized task allocation model is performed based on reinforcement learning using a policy network,
the policy network receives the task allocation model as an input and outputs an action among possible actions based on probability distribution over the actions, the action corresponding to a change on at least one of the execution order of the operations or the target device for executing one or more of the operations,
the policy network is updated according to a reward determined by performance evaluation of the action in runtime environments for executing the computation graph.

15. The apparatus of claim 14, wherein the reward is determined based on execution delay or memory usage efficiency.

16. The apparatus of claim 9, wherein the task allocation model further includes information of a processing element of the target device for executing each of the operations, and the task allocation model is represented by a sequence of nodes and a sequence of processing elements.

17. A non-transitory computer readable medium that stores a set of instructions that is executable by at least one processor of a computing device to cause the computing device to perform a method for scheduling a computation graph on a heterogeneous computing resource including one or more target devices for executing the computation graph, the computation graph including a plurality of nodes and edges, each edge connecting two nodes among the plurality of nodes, the method comprising:
partitioning the computation graph into a plurality of subsets, each subset includes at least two nodes;
generating one or more task allocation models for each subset of the plurality of subsets, wherein a task allocation model includes information of an execution order of operations represented by at least two nodes of the corresponding subset and of a target device of the one or more target devices for executing each of the operations;
determining an optimized task allocation model for each of the plurality of subsets based on the generated one or more task allocation models; and
combining each determined optimized task allocation model for each of the plurality of subsets into a combined model corresponding to the computation graph.

18. The computer readable medium of claim 17, wherein the task allocation model is represented by a sequence of nodes and a sequence of target devices.

19. The computer readable medium of claim 17, wherein partitioning the computation graph is performed by cutting a single edge connecting two subsets of the plurality of the subsets.

20. The computer readable medium of claim 17, wherein the set of instructions that is executable by at least one processor of the computing device to cause the computing device to further perform:
replacing a subgraph including at least two nodes among the plurality of nodes included in the computation graph with a super node before partitioning the computation graph.

21. The computer readable medium of claim 20, wherein a target device among the one or more target devices for executing the single node replaced from the subgraph is determined based on a prior execution history.

22. The computer readable medium of claim 17, wherein:
determining the optimized task allocation model is performed based on reinforcement learning using a policy network,
the policy network receives the task allocation model as an input and outputs an action among possible actions based on probability distribution over the actions, the action corresponding to a change on at least one of the execution order of the operations or the target device for executing one or more of the operations,
the policy network is updated according to a reward determined by performance evaluation of the action in runtime environments for executing the computation graph.

23. The computer readable medium of claim 22, wherein the reward is determined based on execution delay or memory usage efficiency.

24. The computer readable medium of claim 17, wherein the task allocation model further includes information of a processing element of the target device for executing each of the operations, and the task allocation model is represented by a sequence of nodes and a sequence of processing elements.
